(19) United States
(12) Patent Application Publication
(10) Pub. No.: US 2016/0307589 A1
(43) Pub. Date: Oct. 20, 2016

(54) HOLOGRAM RECORDING AND PLAYBACK DEVICE AND PLAYBACK POSITION DEVIATION DETECTION METHOD

(71) Applicant: Hitachi-LG Data Storage, Inc., Tokyo (JP)

(72) Inventors: Tatsuro IDE, Tokyo (JP); Kouichirou NISHIMURA, Tokyo (JP)

(73) Assignee: Hitachi-LG Data Storage, Inc., Tokyo (JP)

(21) Appl. No.: 15/132,342

(22) Filed: Apr. 19, 2016

(30) Foreign Application Priority Data
Apr. 20, 2015 (JP) 2015-085770

(51) Int. Cl. G11B 7/007; G11B 7/0065

(52) U.S. Cl. CPC G11B 7/00781; G11B 7/0065

(57) ABSTRACT

A hologram recording and playback device and a playback position deviation detection method to detect the relative position deviation between the hologram and reference light during playback with high sensitivity. The hologram recording and playback device records as a servo page, signal light added with two-dimensional pattern data having a cycle induced by the spatial modulator in a least a portion of the data. During playback, reference light is emitted onto the servo page, and an optical detector mounted on the periphery of a light transmittance unit of a spatial filter detects the playback light, and detects the position deviation versus the servo page. By utilizing a check pattern for example as the two-dimensional pattern, a diffraction peak can be generated on the periphery of the light transmittance unit and position deviation can be detected with high sensitivity.

### CLAIM OF PRIORITY

The present application claims priority from Japanese patent application serial No. JP 2015-085770, filed on Apr. 20, 2015, the content of which is hereby incorporated by reference into this application.

### BACKGROUND OF THE INVENTION

(1) Field of the Invention

The present invention relates to a recording and playback device that records and plays back information on an optical information recording medium by utilizing holography and to a playback position deviation detection method during playback.

(2) Description of the Related Art

High density recording of a hologram on an optical information recording medium by utilizing a hologram recording and playback device, requires densely spreading and positioning the multiplex-recorded page data (hereafter, called book) on the recording medium simultaneously with increasing the number of angle multiple page data (multiplex count). During playback of the hologram, the reference light emission position and the hologram position must be accurately aligned. A method for accurate positioning during playback is described in Japanese Patent Application Laid-Open No. 2007-304263 that separates a portion of the playback light with a beam splitter, detects position deviations in the playback hologram with a spatial filter from the incoming light that is received by quadrature photodetector, and shifts the hologram medium to correct the position. WO2014/083619A1 describes a method for correcting position deviations by detecting position deviations in the playback hologram relative to reference light by detecting the playback light that is emitted to the periphery of the aperture of the spatial filter, and shifts a mechanism (e.g. spatial filter) for the recording and playback device.

In contrast to Japanese Patent Application Laid-Open No. 2007-304263 that shifts the hologram medium to correct a position deviation, the technology of WO2014/083619A1 for example shifts a spatial filter to correct a position deviation. A comparison shows that the method that shifts the light-weight spatial filter gives excellent access and is well-suited for high-speed playback. However, the detection method of WO2014/083619A1 detects deviations in the intensity distribution of the playback light on the periphery of the aperture of the special filter through which the playback light passes and so the smaller the amount of position deviation, the weaker the optical intensity on the periphery of the aperture becomes, causing the problem of a drop in the position deviation detection sensitivity.

An object of the present invention is to provide a hologram recording and playback device and a playback position deviation detection method having greater detection sensitivity when detecting the complementary position deviation of the reference light and hologram during playback.

### SUMMARY OF THE INVENTION

A hologram recording and playback device according to one aspect of the present invention includes a spatial light modulator to add data for recording to the signal light; a spatial filter including a light transmittance unit to transmit the signal light attached with data; an objective lens to emit the signal light that has passed through the spatial filter onto the optical information recording medium; and an optical detector to emit reference light on the playback hologram formed on the optical information recording medium, and to detect the playback light emitted over the periphery of the light transmittance unit of the spatial filter from among the acquired playback light; a playback position deviation detection unit to detect the position deviation between the playback hologram and the reference light based on the output from the optical detector; and a position deviation correction unit to correct the position deviation between the playback hologram and the reference light by shifting the position of the optical filter based on the detection signal of the playback position deviation detection unit. The servo page is then recorded using the signal light to which is added two-dimensional pattern data having a cycle induced by the spatial light modulator in at least a portion of the two-dimensional data, and that emits reference light onto the servo page during playback, and detects the position deviation between the playback hologram and reference light by detecting the acquired playback light by an optical detector.

A playback position deviation detection method according to an aspect of the present invention that includes a step to add two-dimensional pattern data having a cycle induced by the spatial light modulator in at least a portion of the two-dimensional data, to the signal light and record the modulated signal light onto the optical information recording medium as a servo page; a step to obtain playback light from the servo page by emitting reference light onto the optical information recording medium; a step to detect the playback light emitted to the periphery of the light transmittance unit by the optical detector positioned on the periphery of the light transmittance unit of the spatial filter; and a step to detect the position deviation between the reference light and the servo page by processing the signal from the optical detector.

The present invention is capable of increasing the detection sensitivity when detecting the relative position deviation of the hologram and reference light during playback and achieving high positioning accuracy. Consequently, the present invention is capable of stable detection of position deviations even during high density recording of a book onto an optical information recording medium and thus contributing to achieving large capacity hologram recording.

### BRIEF DESCRIPTION OF THE DRAWINGS

FIG. 1A, FIG. 1B, and FIG. 1C are drawings for describing the method for increasing the position deviation signal of the present embodiment, in which FIG. 1A is an example of a unique two-dimensional pattern utilized as the servo page, FIG. 1B is a shape of the spatial filter, and FIG. 1C is an intensity distribution of the signal light on the spatial filter;

FIG. 2 is a block diagram showing the entire structure of the hologram recording and playback device;

FIG. 3 is a drawing showing the internal structure and the recording operation of the optical pickup;

FIG. 4 is a drawing showing the internal structure and the playback operation of the optical pickup;

FIG. 5 is diagrams showing the hologram data for multiplex-recording on the optical information recording medium;

FIG. 6 is a diagram showing the internal structure and the record signal processing of the signal generation circuit for recording;

FIG. 7 is a diagram showing the internal structure and the playback signal processing of the signal processing circuit for playback;

FIG. 8A is a chart showing the data processing flow during recording;

FIG. 8B is a chart showing the data processing flow during playback;

FIG. 9A and FIG. 9B are diagrams showing the playback position deviation detection method by utilizing a spatial filter, in which FIG. 9A shows the optical incidence angle of the spatial filter and FIG. 9B shows the internal structure of the playback position deviation detection circuit;

FIG. 10 is drawings showing the relation between the position deviation amount and the detection signal;

FIG. 11 is a drawing showing the playback optical system when a playback position deviation occurs;

FIG. 12 is a drawing showing the method for correcting the playback position deviation;

FIG. 13A, FIG. 13B, FIG. 13C, and FIG. 13D are drawings and images showing other examples of two-dimensional patterns for localizing (setting the position) the signal light, in which FIG. 13A shows a random pattern for comparison, FIG. 13B shows a check (checkered) pattern, FIG. 13C shows a rectangle ring pattern, and FIG. 13D shows an elliptical ring pattern; and

FIG. 14A and FIG. 14B are graphs showing the improvement effect in the playback position deviation detection signal of the present embodiment, in which FIG. 14A shows (the X direction and Y direction detection signal levels in) the case of a random pattern for comparison, and FIG. 14B shows (the X direction and Y direction detection signal levels in) the case of a check pattern.

### DETAILED DESCRIPTION OF THE PREFERRED EMBODIMENTS

The embodiments of the present invention are hereafter described while referring to the drawings.

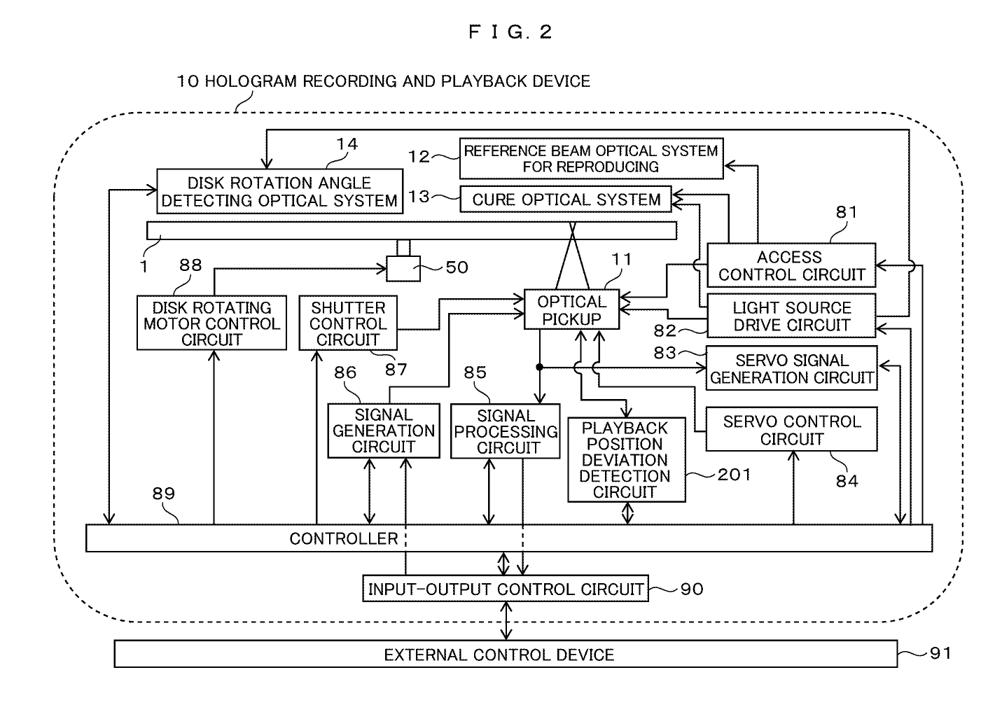

FIG. 2 is a block diagram showing the entire structure of the hologram recording and playback device. The hologram recording and playback device 10 is coupled to an external control device 91 by way of an input-output control circuit 90. During recording of information, the input-output control circuit 90 receives information signals for recording, from the external control device 91. During playback, the input-output control circuit 90 sends the information signals for playback to the external control device.

The hologram recording and playback device 10 includes an optical pickup 11, a reference beam optical system for reproducing 12, a cure optical system 13, a disk rotation angle detecting optical system 14, and a rotating motor 50. The optical information recording medium 1 is configured to be rotatable by the rotating motor 50.

The optical pickup 11 emits reference light and signal light onto the optical information recording medium 1 and records the digital information onto the recording medium by utilizing holography. The controller 89 at that time sends an information signal for recording by way of the signal generation circuit 86 to the spatial light modulator within the optical pickup 11, and the spatial light modulator modulates the signal light.

In order to playback information that is recorded on the optical information recording medium 1, the reference beam optical system for reproducing 12 generates light waves (reference light for playback) for irradiating the reference light emitted from the pickup 11 onto the optical information recording medium 1 in the direction opposite the recording direction. A subsequently described optical detector within the optical pickup 11 detects the playback signal light that is played back by utilizing the reference light for playback, and the signal processing circuit 85 plays back the signal.

The emission time of the reference light and the signal light that is emitted onto the optical information recording medium 1 is adjusted by the controller 89 controlling the shutter opening-closing time within the optical pickup 11 by way of the shutter control circuit 87.

The cure optical system 13 fulfills the task of generating a light beam utilized for pre-cure and post-cure of the optical information recording medium 1. Pre-cure is a pre-process for emitting a specified light beam prior to emitting reference light and signal light onto a desired position, when recording information onto a desired position within the optical information recording medium 1. Post-cure is a post-process for emitting a specified light beam onto the desired position in order to create post-scripts (after notes) that cannot be formed after recording of information onto the desired position within the optical information recording medium 1.

The disk rotation angle detecting optical system 14 is utilized for detecting the rotation angle of the optical information recording medium 1. When adjusting the optical information recording medium 1 to a specified rotation angle, the disk rotation angle detecting optical system 14 detects the signal corresponding to the rotation angle, and the controller 89 utilizes the detected signal to control the rotation angle of the optical information recording medium 1 by way of the disk rotating motor control circuit 88.

The specified light source drive current from the light source drive circuit 82 is supplied to each of the light sources in the optical pickup 11, the cure optical system 13, and the disk rotation angle detecting optical system 14, and each light source emits the light beam at the specified amount of light. The optical pickup 11 and the cure optical system 13 include a mechanism capable of sliding the position in the radial direction of the optical information recording medium 1, and whose position is controlled by way of the access control circuit 81.

However, in recording systems utilizing the principle of holography angular multiplexing, the tolerance error for reference light angle deviation is extremely small. A mechanism for detecting the amount of reference light deviation is therefore mounted within the optical pickup 11, and a servo mechanism is mounted to generate a servo control signal in the servo signal generation circuit 83 and to correct the amount of deviation by way of the servo control circuit 84.

The playback position deviation detection circuit 201 is a circuit that detects playback position deviations based on signals obtained in the optical pickup 11, and the detected playback position deviation information is input to the controller 89 and the necessary control information is applied in the servo control circuit 84 and the access control circuit 81, etc.

The optical pickup 11, the cure optical system 13, and the disk rotation angle detecting optical system 14 may be multiple optical systems or may be a simplified arrangement where all optical structures are integrated into one structure.

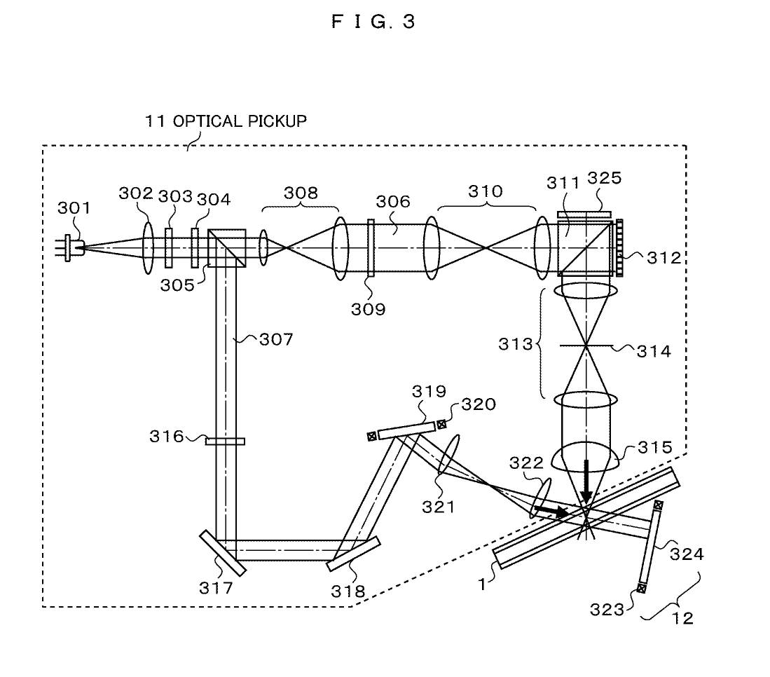

FIG. 3 is a drawing showing the internal structure and the recording operation of the optical pickup 11. The light beam emitted from the light source 301 transmits through the collimator lens 302 and is emitted onto the shutter 303. After passing through the shutter 303 while the shutter 303 is open, the light beam is input to the polarized beam splitter (PBS) prism 305 after being controlled by the optical element 304 configured for example from a half-wave plate in order to control the direction of polarization to attain the desired light quantity ratio of p polarized light and s polarized light.

The light beam that transmitted through the polarized beam splitter (PBS) prism 305, functions as the signal light 306, and after the beam expander 308 widens the light beam diameter, the light beam (signal light) transmits through the phase mask 309, the relay lens 310, and the PBS prism 311 and is input to the spatial light modulator 312.

The signal light 306 having two-dimensional information attached by the spatial light modulator 312, is reflected by the PBS prism 311, and propagates through the relay lens 313 and spatial filter 314. In that case, the signal light 306 is converged by the relay lens 313 and passes through the aperture of the spatial filter 314. The objective lens 315 then focuses the signal light onto the optical information recording medium 1. The phase mask 309 applies a random phase (wavefront aberration) to the signal light 306, and diffuses the signal light on the spatial filter 314 and the optical information recording medium 1 so that the signal light is focused by the objective lens 315. The optical phase mask 309 is in this way fulfills the task of locally exposing the optical information recording medium 1 and eases limits on the multiplexing of information onto the same point.

The light beam reflected by the PBS prism 305 on the other hand functions as the reference light 307, and after the polarization direction converter element 316 sets a specified polarizing direction corresponding to whether during recording or during playback, the reference light 307 is emitted onto the Galvano mirror 319 by way of the mirrors 317, 318. The angle of the Galvano mirror 319 is adjustable by the actuator 320, and can set the incidence angle of the reference light emitted onto the optical information recording medium 1 after passing through the lenses 321, 322 to a desired angle. An element to convert the wavefront of the reference light may be utilized instead of the Galvano mirror 319 to set the incidence angle of the reference light.

By mutually overlapping the signal light and reference light on each other for emission onto the optical information recording medium 1 in this way, an interference fringe is formed within the recording medium, and information is recorded by writing this pattern on the record medium. Data recorded by way of reference light at one incidence angle is called a “page.” Recording by angular multiplexing is performed by changing the incidence angle of the reference light to be incident on the optical information recording medium 1 by the Galvano mirrors 319. Multiplex-recorded data made by changing the incidence angle of the reference light is called a “book.”

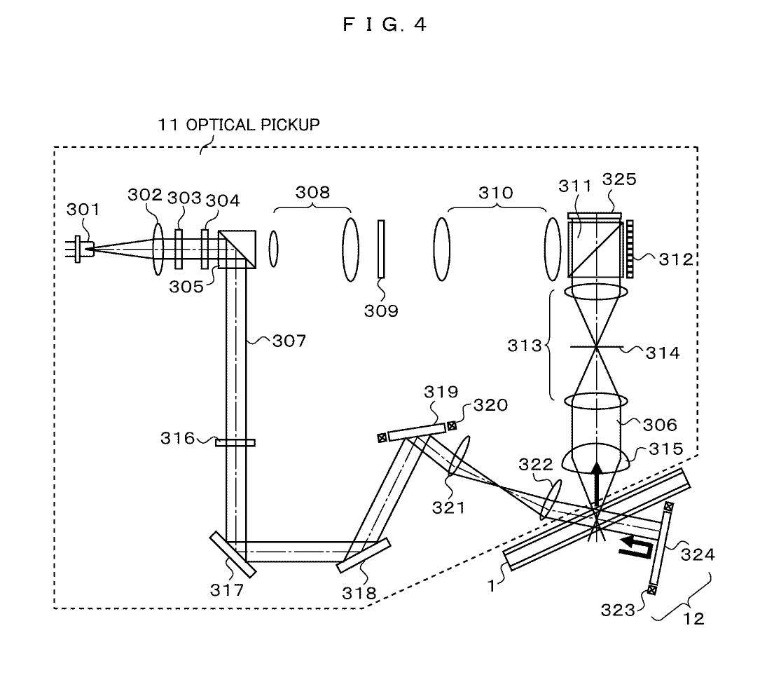

FIG. 4 is a drawing showing the internal structure and the playback operation of the optical pickup 11. When playing back the information that is recorded, the reference light 307 is input to the optical information recording medium 1, and the light beam that transmitted through the optical information recording medium 1 is guided to the reference beam optical system for reproducing 12, and reference light for playback is generated by utilizing an actuator 323 to reflect the light beam by angle-adjustable Galvano mirror 324.

The reproduced signal light 306 that is played back by this reference light for playback, passes through the objective lens 315, the relay lens 313, and the spatial filter 314. The playback light then passes through the PBS prism 311 and is incident on the imaging element 325, and plays back the recorded signal. Imaging devices such as a CMOS image sensor and CCD image sensor can for example be utilized as the imaging element 325, however if capable of playing back the page data then any element may be utilized.

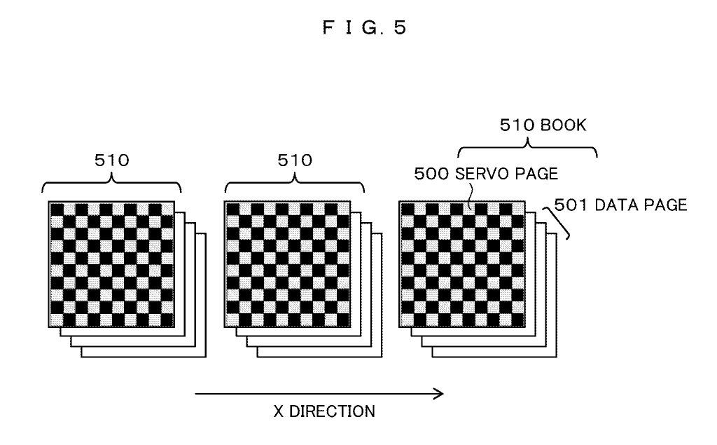

FIG. 5 is diagrams showing the hologram data for multiplex-recording on the optical information recording medium. Here, plural books 510 are adjacently recorded along the X direction and playback positioning is performed by utilizing the servo page when playing back each book. Therefore during book recording, along with multiplex-recording of the plural data pages 501 by changing the angle of the reference light, a servo page 500 having a unique pattern to allow detection of playback position deviation is additionally recorded. A servo page 500 and plural data pages 501 are recorded at the same position on the optical information recording medium 1 to form one book 510. Positioning the servo page 500 during playback also positions all data pages 501 contained within the same book.

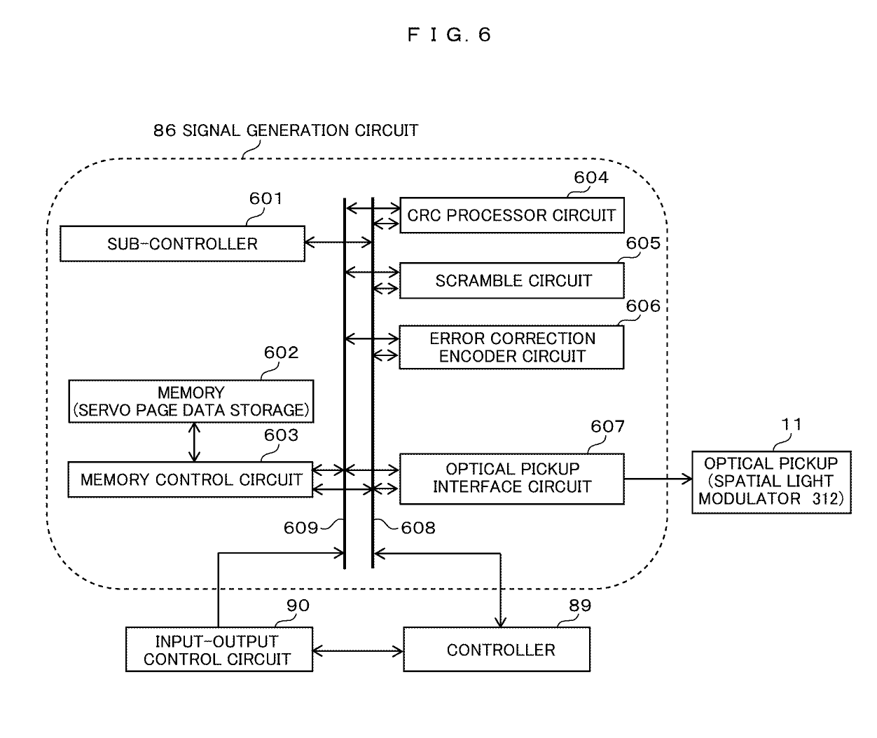

FIG. 6 is a diagram showing the internal structure and the record signal processing of the signal generation circuit 86 for recording. When input of user data to the input-output control circuit 90 starts, the input-output control circuit 90 notifies the controller 89 of the start of user data input. The controller 89 receives this notification and instructs the signal generation circuit 86 to perform record processing of a one page portion of data that is input from the input-output control circuit 90. The processing instruction from the controller 89 is notified by way of the control line 608 to the sub-controller 601 within the signal generation circuit 86. The sub-controller 601 that receives this notification controls each signal processing circuit by way of the control line 608 so as to operate each of the signal processing circuits in parallel.

First of all, the memory control circuit 603 is controlled so as to store the user data input from the input-output control circuit 90 into the memory 602 by way of the data line 609. When the user data stored in the memory 602 reaches a specified quantity, the CRC processor circuit 604 controls the CRC processing on the user data. Next, the scramble circuit 605 applies a pseudorandom number string to the CRC-processed data to scramble the data, and the error correction encoder circuit 606 applies a parity data string to perform error-correction encoding. The optical pickup interface circuit 607 reads out the error-correction encoded data from the memory 602 in the order of the two-dimensional data on the spatial light modulator 312, and after adding markers as a standard during playback, transfers the two-dimensional data to the spatial light modulator 312 within the optical pickup 11.

In the present embodiment, along with storing the user data, the memory 602 also stores the servo page 500 data in advance. The servo page 500 is a page that is utilized for detecting deviations in the reference light and book position during data playback; and is configured from unique pattern data such as the “check pattern” described later on. By inserting the servo page into a book and recording it, the playback positon deviation in each data page contained in the book can be corrected. The sub-controller 601 controls the optical pickup interface circuit 607 to read out the servo page data from the memory 602, and transfers the servo page data as two-dimensional data to the spatial light modulator 312 within the optical pickup 11.

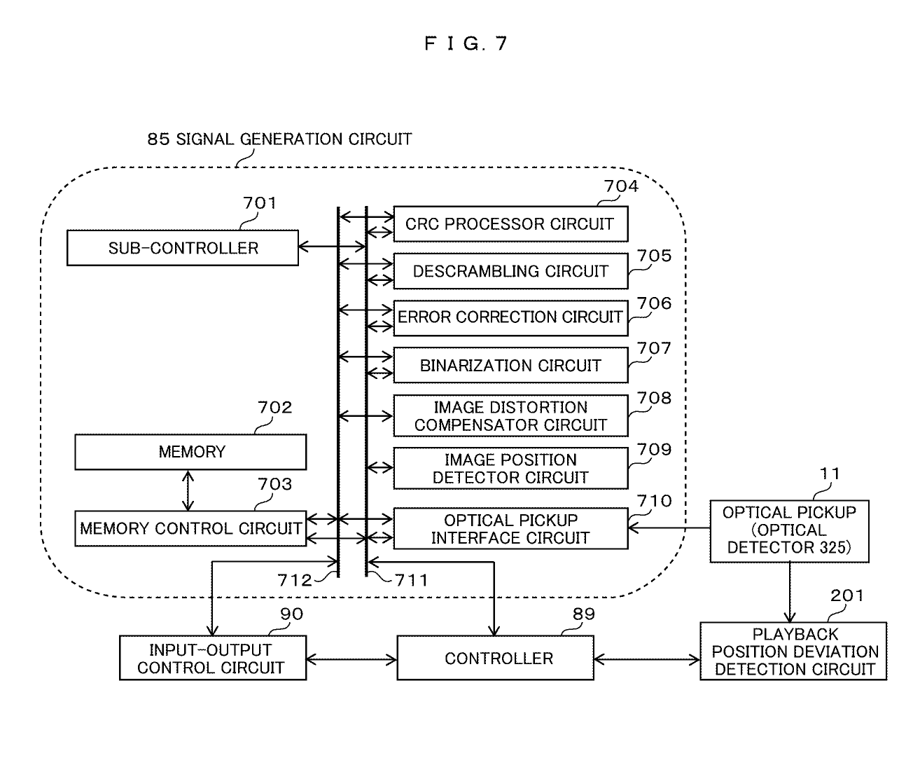

FIG. 7 is a diagram showing the internal structure and the playback signal processing of the signal processing circuit 85 for playback. Here, the playback processing of the data page 501 by the signal processing circuit 85 is described. The playback position deviation detection circuit 201 performs processing for playback of the servo page 500. The controller 89 controls the switching of the data page and servo page processing.

When the imaging element 325 within the optical pickup 11 detects the image data, the controller 89 instructs the signal processing circuit 85 to perform playback processing of a one page portion of data input from the optical pickup 11. The processing instruction from the controller 89 is notified by way of the control line 711 to the sub-controller 701 within the signal processing circuit 85. The sub-controller 701 receives this instruction and controls each of the signal processing circuits by way of the control line 711 to operate each of the signal processing circuits in parallel. First of all, the memory control circuit 703 is controlled so that the image data input by way of the optical pickup interface circuit 710 from the optical pickup 11 by way of the data line 712 for storage in the memory 702.

When the amount of data that is stored in the memory 702 reaches a specified amount, the image position detector circuit 709 is controlled to detect a marker from among the image data stored in the memory 702 and extract the effective data range. Next, the image distortion compensator circuit 708 corrects distortion such as in the slope, magnification, and distortion in the image by utilizing the detected markers, and converts the image data to the size of the desired two-dimensional data. The binarizer circuit 707 converts the each bit data from the plural bits contained in the two-dimensional data that the size is converted into binary numbers determined as “0” or “1”, and stores the data in the playback data output array in the memory 702. Next, the error correction encoder circuit 706 corrects the errors contained in each data string, and after the descrambling circuit 705 descrambles the pseudorandom number data strings that are added, the CRC processor circuit 704 confirms there are no errors contained within the user data in the memory 702; and the user data is then transferred from the memory 702 to the input-output control circuit 90.

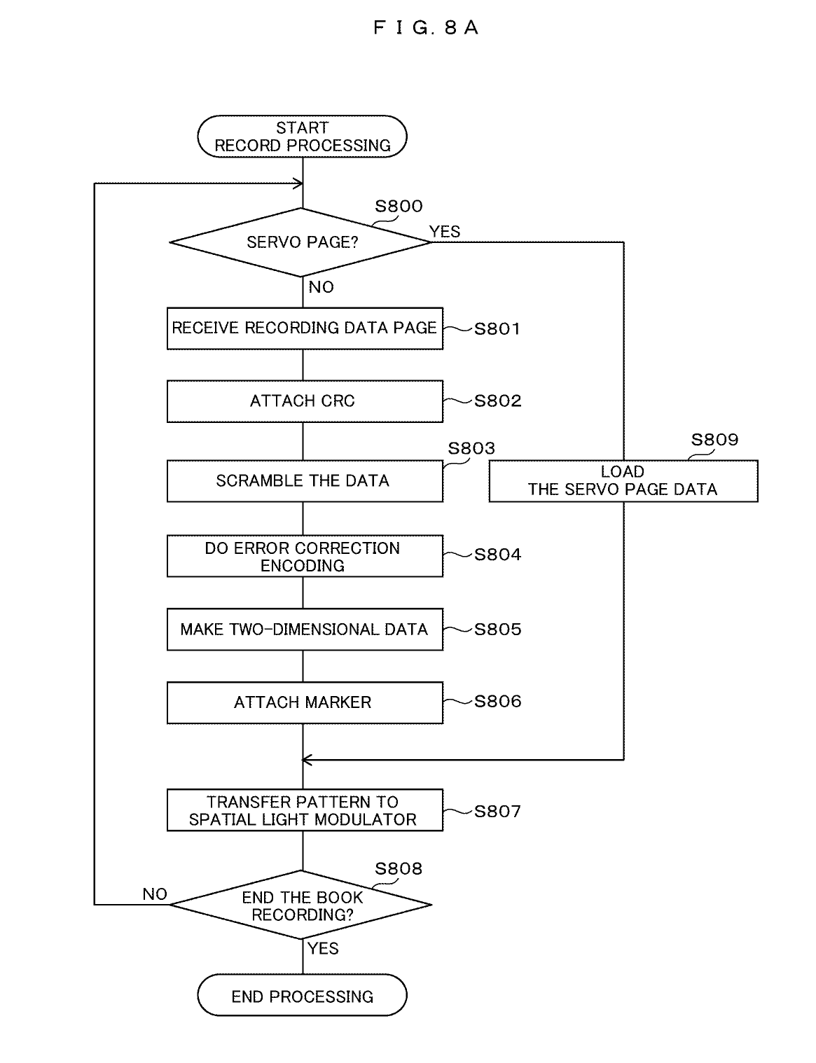

FIG. 8A and FIG. 8B are charts showing the data processing flow during recording and playback.

FIG. 8A shows the record data processing flow, and shows the processing from receiving the record data in the input-output control circuit 90 to the conversion of the record data into two-dimensional data on the spatial light modulator 312 by the signal generation circuit 86.

The record data is first of all judged as a servo page or a data page (S800). In the case of a servo page, the servo page data is read-out (loaded) from the memory 602 (S809) and the data pattern is transferred to the spatial light modulator (S807). If there is a predetermined record sequence for the servo page (e.g. set as first page), it can be judged as servo page from the page number.

When the data for recording is a data page, the user data is received (S801). In the signal processing for the user data, the data is sub-grouped into plural data strings, CRC processing is performed on each data string so as to detect errors during playback (S802), the number of on-pixels made equivalent to the number of off-pixels, and after performing scrambling to add pseudorandom number data strings to the data strings with the object of preventing repetition of the same patterns (S803), error correction coding such as Reed-Solomon coding is applied to correct errors during playback (S804). Next, this data string is converted to a M×N two-dimensional data, and by repeating this as a one page portion of data, a one page portion of two-dimensional data is formed (S805). A marker serving as the standard for image position detection and image distortion correction is added to the two-dimensional data formed in this way (S806).

The page data (two-dimensional pattern) whose signal processing is completed, is transferred to the spatial light modulator 312 (S807). A judgement is made on whether recording of page data contained in one book is finished or not (S808), and if there is remaining data, the processing returns to S800 and the above described processes are repeated.

FIG. 8B shows the playback data processing flow, and shows the processing in the signal processing circuit 85 up to the sending of playback data by the input-output control circuit 90, after the imaging element 325 detects the two-dimensional data.

A judgment is first of all made on whether the data for playback is a servo page or a data page (S810). In the case of a servo page, the playback position deviation detection circuit 201 detects the position deviation between the reference light and the playback hologram (S822). The position deviation is corrected by shifting the position of the spatial filter 314 as subsequently described, based on the detected position deviation (S823). If the processing sequence for the servo page is the beginning of the book, the position deviations during subsequent page playback can be eliminated.

If the data to playback is a data page, the image data detected by the image element 325 is transferred to the signal processor circuit 85 (S811). In the signal processing of image data, the image position is detected based on the markers contained in the image (S812), and after correcting the distortion such as the slope, magnification, and distortion in the image (S813), binarizing is performed(S814), and by eliminating the markers (S815), a one page portion of two-dimensional data is obtained (S816). After converting the two-dimensional data obtained in this way into plural data strings, error correction processing is performed (S817), and the parity data strings are eliminated. Next, the descrambling processing is performed (S818), and the CRC parities are removed by performing error detection processing by CRC (S819).

The page data whose signal processing is completed, is sent by way of the input-output control circuit 90 (S820). A judgement is made on whether playback of page data contained in one book is complete or not (S821), and if there is remaining data, the processing returns to S810 and the above described processes are repeated.

The method for detecting and correcting a position deviation during data playback is described next. When a position deviation occurs in the relative positions of the reference light 307 and hologram during playback, a drop occurs in the playback output of the imaging element 325. In the present embodiment, a position deviation in the relative positions of the reference light and hologram is detected by detecting the playback signal light emitted on the aperture periphery of the spatial filter 314, and the position deviation is corrected by shifting the position of the spatial filter 314.

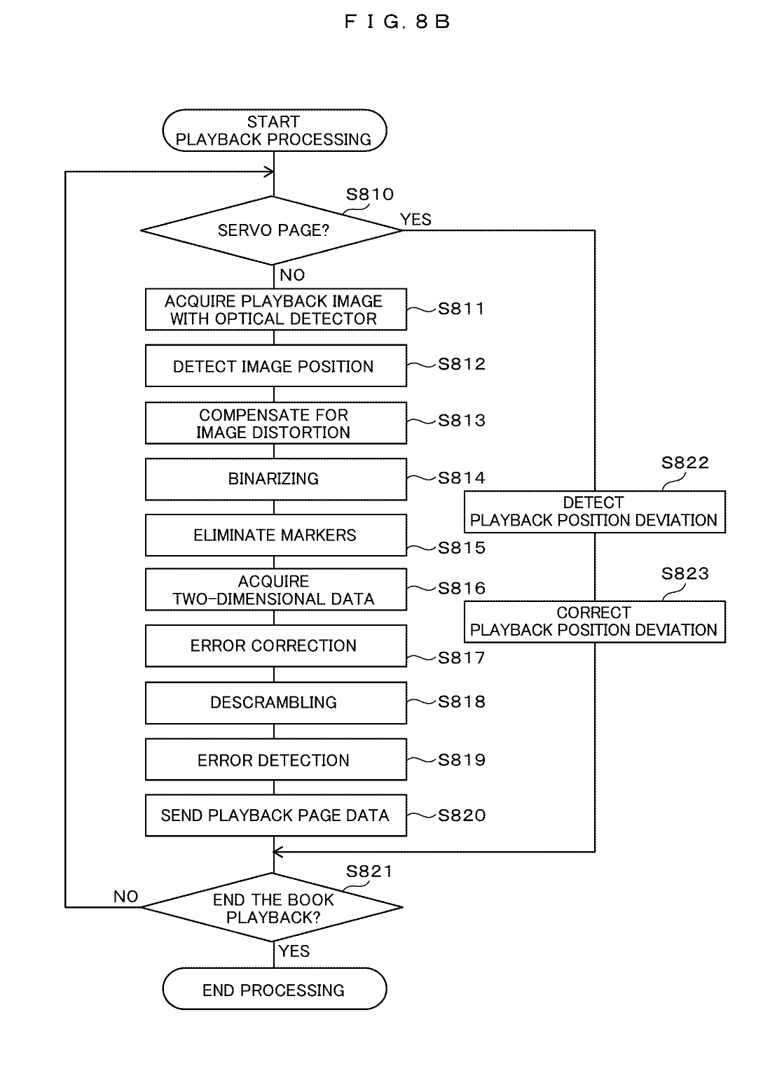

FIG. 9A and FIG. 9B are diagrams showing the playback position deviation detection method utilizing a spatial filter.

FIG. 9A shows the optical incident surface of the spatial filter 314 that includes a light transmittance unit (aperture) 314a in the center section. The aperture shape is triangular and this type of filter is called a “polytopic filter.” The playback signal light on the optical axis 901 passes through the light transmittance unit (aperture) 314a. When the optical information recording medium 1 is a circular disk, the X direction is along the circumference and the Y direction is along the radius. Four optical detectors 906 (shown as A to D) are placed on the playback light incident side of the light transmittance unit 314b on the periphery of the light transmittance unit 314a of the spatial filter 314. These optical detectors A and B enclose the light transmittance unit 314a in opposing X directions, and the optical detectors C and D enclose the light transmittance unit 314a in opposing Y directions.

FIG. 9B shows the internal structure of the playback position deviation detection circuit 201. The signals from the optical detectors A through Dare input to the playback position deviation detection circuit 201 by way of the signal line 905 and the playback position deviation detection signals (A-B), (C-D) along the X direction and the Y direction are obtained by logical difference processing by the two subtraction circuits 902, 903. For example, when a position deviation AX in the playback signal light occurs along the X axis plus direction, the signal light is input weighted toward the optical detector A so that an (A-B)>0 signal is output by way of the subtraction circuit 902 of the playback position deviation detection circuit 201. In the same way, when a position deviation AY in the playback signal light occurs along the Y axis plus direction, the signal light is input weighted toward the optical detector C so that an (C-D) >0 signal is output by way of the subtraction circuit 903 of the playback position deviation detection circuit 201. The playback position deviation amount and deviation direction can in this way be detected from the detection signal (A-B), (C-D).

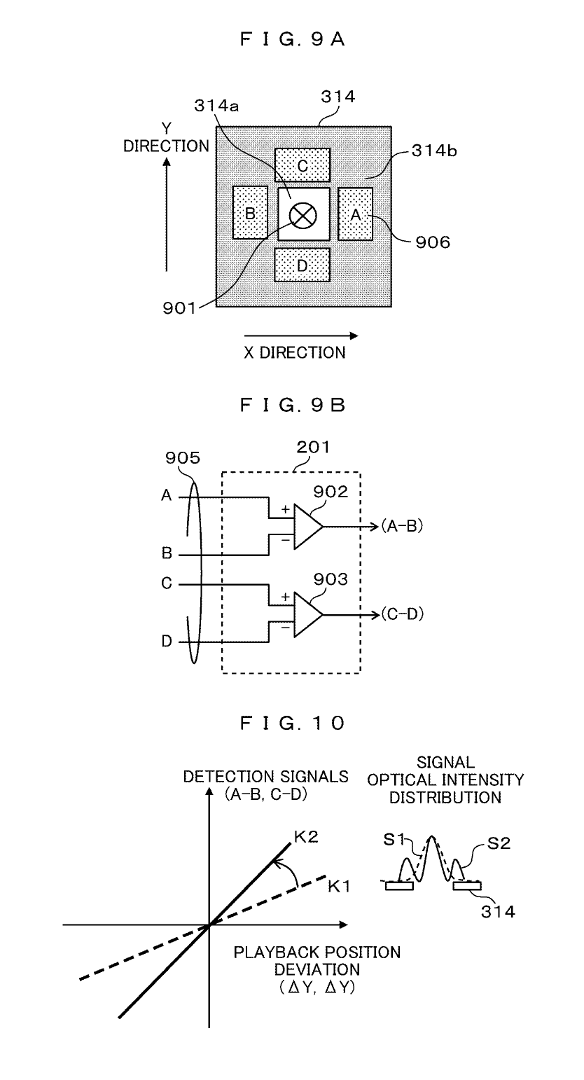

FIG. 10 is drawings showing the relation between the position deviation amount and the detection signal. In FIG. 10, the horizontal axis shows the deviation amounts ΔX and ΔY in the X direction and Y direction, and the vertical axis shows the detection signals (A-B), (C-D) from the playback position deviation detection circuit 201. The detection signals are obtained of course largely proportional to the amount of deviation. The slope of the straight line (gradient) K1, K2 is dependent on the sensitivity of the optical detector 906 and the intensity of the playback signal light.

When the intensity distribution of the playback signal light input to the spatial filter 314, is a single peak such as shown by the broken line S1, the optical intensity in the light shielding unit 314b where the optical detector 906 is mounted is low and the gradient (K1) of the detection signal is small. In this case, if the intensity in the center section of the playback signal light is increased, the intensity in the light shielding unit 314b on the periphery can also be increased, however, the peak intensity of emission from the light source will be limited.

However, if the intensity distribution of the playback signal light could have plural peaks as shown by the solid line S2, the optical intensity in the light shielding unit 314b will become high and the gradient (K2) of the detection signal will become large. Whereupon in the present embodiment, a unique two-dimensional pattern such as subsequently described is used in the servo page so that the intensity distribution of the playback signal light becomes the distribution in the solid line S2.

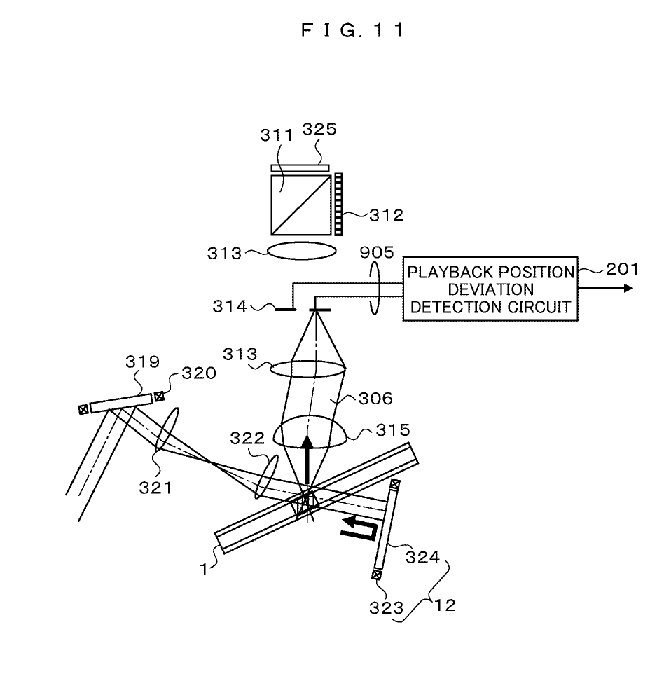

FIG. 11 is a drawing showing the playback optical system when a playback position deviation occurs. When a book playback position deviation occurs, the position of the reproduced signal light 306 deviates from the light transmittance unit (aperture) 314a of the spatial filter 314 and light is emitted onto the position of the light shielding unit (periphery) 314b of spatial filter 314. As a result of this the reproduced signal light 306 cannot reach the imaging element 325 or even if it reaches it the playback signal level is attenuated. Whereupon the optical detectors 906 (A to D) on the spatial filter 314 shown in FIG. 9 detect the signal light emitted to the light shielding unit 314b, and the playback position deviation detection circuit 201 detects the amount of deviation by way of the signal line 905.

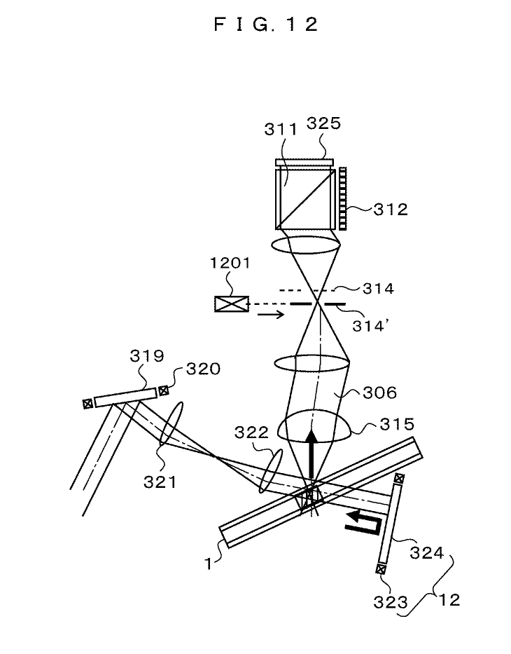

FIG. 12 is a drawing showing the method for correcting the playback position deviation. Here, as the correction method, an actuator (position deviation corrector unit) 1201 capable of X and Y direction movement, shifts the spatial filter 314 position to the 314′ position. The reproduced signal light 306 can in this way transmit through the light transmittance unit (aperture) 314a of the spatial filter 314 and can reach the imaging element 325. The servo signal generation circuit 83 determines the amount of position deviation of the spatial filter 314 based on the detection signal (A-B), (C-D) in the playback position deviation detection circuit 201, and controls the actuator 1201 by way of the servo control circuit 84. The correction is then complete at the point in time that the detection signal (A-B), (C-D) falls within a predetermined threshold. When positioning is complete, the playback of the page data starts.

In the present embodiment, the optical detector 906 (A to D) shown in FIG. 9A is positioned on the spatial filter 314. However, the present embodiment is not limited to a mounting position on the spatial filter 314 and the optical detector 906 may be mounted on a surface optically equivalent in value to the spatial filter 314. A beam splitter for example may be mounted between the spatial filter 314 and the objective lens 315 to split off a portion of the playback signal light, and the separated signal light focused onto the lens, and an optical detector may be mounted on the focal surface of the lens.

In FIG. 12, the position of the spatial filter 314 was shifted to correct the playback position deviation however the embodiment is not limited to this arrangement. The spatial filter 314 for example may be clamped and the objective lens 315 may be shifted, or the optical information recording medium 1 may be shifted.

Here, the method for increasing the intensity of the playback position deviation signal in the present embodiment is described. As already described, the optical detector 906 detects signal light that does not pass through the light transmittance unit 314a of the spatial filter 314 from among the signal light 306 during playback or namely detects the amount of light (intensity) of the light shielding unit 314b. Here, when a regular data page (two-dimensional random pattern) is recorded, the intensity of the signal light 306 played back from that pattern peaks at the optical axis 901 but weakens as it nears the periphery on the spatial filter 314. Therefore, the amount of light (intensity) of the signal light emitted onto the light shielding unit 314b of the spatial filter is small to begin with, and the signal level capable of being detected at the optical detector 906 mounted on the light shielding unit 314b is low even if a position deviation occurs between the reproduced signal light 306 and the spatial filter 314 causing the problem that the position deviation signal becomes weak (gradient K in FIG. 10 is small).

Whereupon, the present embodiment is configured so that a peak intensity of the signal light 306 that is played back is generated not only at the light transmittance unit 314a of the spatial filter 314 but also at the light shielding unit 314b on the periphery and the optical intensity increases on the optical detector 906. In other words, as shown in FIG. 10, the intensity distribution is changed from S1 to S2 and the sensitivity improved from K1 to K2. The position deviation is therefore detected and corrected by inputting and playing back a servo page having a unique two-dimensional pattern. The position deviation relative to the book playback position deviation can be detected with high accuracy, and book playback position control and page data playback performed with good accuracy.

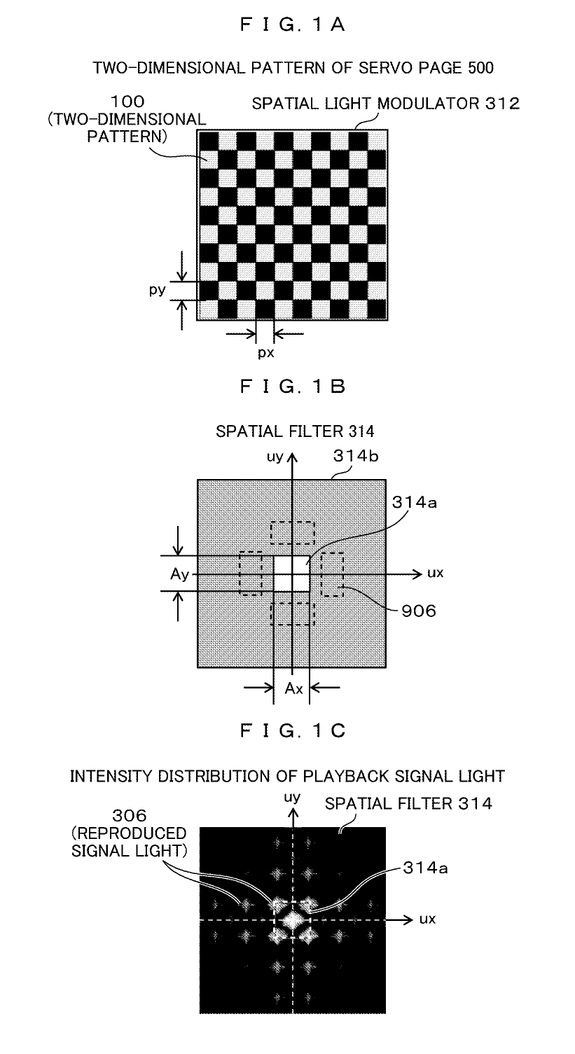

FIG. 1A, FIG. 1B, and FIG. 1C are drawings for describing the method for increasing the position deviation signal by the present embodiment. FIG. 1A is an example of unique two-dimensional pattern utilized as the servo page 500. FIG. 1B shows the shape of the spatial filter 314. FIG. 1C shows the intensity distribution of the reproduced signal light 306 on the spatial filter 314.

As shown in FIG. 1A, the two-dimensional check pattern (checkered pattern) for recording is for example utilized as a two-dimensional pattern 100 displayed and recorded on the spatial light modulator 312. Namely, this is a pattern for alternately arraying the pixels for signal “1” and “0” in the X direction and the Y direction. When signal light modulated by a two-dimensional pattern having this type of cycle is converged by the relay lens 313, a diffraction peak can be generated by a diffraction phenomenon on the spatial filter 314 mounted on the focal surface.

FIG. 1C shows the intensity distribution of the reproduced signal light 306 on the spatial filter 314, and besides the peak on the center of the optical axis, a diffraction peak occurs at fixed intervals in the X direction and Y direction or in other words, the peak position is localized. The position (interval) where this diffraction peak occurs is dependent on the pitch (pixel size) px, py of the two-dimensional pattern 100. This phenomenon also occurs during playing back of a unique pattern the same as during recording of a unique pattern. Therefore, if the pitch of the two-dimensional pattern 100 can be set so that the diffraction peak position aligns with the sizes Ax, Ay of the light transmittance unit 314a of the spatial filter 314 in FIG. 1B, the amount of light (intensity) of the signal light emitted onto the light shielding unit 314b of the spatial filter 314 will increase. Namely, when a deviation occurs in the relative positions of the reference light 307 and hologram, the optical detector 906 mounted on the light shielding unit 314b can efficiently detect the reproduced signal light 306, and can detect the playback position deviation with high sensitivity.

Here, the relation between the pitch of the two-dimensional pattern 100 and the size of the light transmittance unit 314a of the spatial filter 314 for generating a diffracted light peak from the reproduced signal light 306 in the periphery of the light transmittance unit 314a of the spatial filter 314 is described. The pitch (pixel size) in the X, Y directions of the two-dimensional pattern in the spatial light modulator 312 is set as px, py, the wavelength of the light source 301 as λ (lambda), and the focal distance of the relay lens 313 is set as f. The (m, n) next light diffraction positions (ux, uy) of the signal light 306 on the focal surface of the relay lens 313 are given by:

ux=m·f·λ/px, uy=n·f·λ/py (m, n are integers) (1)

When the size of the light transmittance unit 314a of the spatial filter 314 is set as Ax, Ay; ux≈Ax, uy≈Ay is sufficient for focusing the diffracted light onto the periphery (edge) of the light transmittance unit 314a so that the pixel size px, py of the two-dimensional pattern can be set as:

px≈m·f·λ/Ax, py≈n·f·λ/Ay (m, n are integers) (2)

More specifically, in the case for example of Ax=Ay=2 mm, λ (lambda)=405 nm, f=40 mm, m=n=1, a setting of px≈py≈8.1 μm is sufficient.

Patterns other than a check pattern are also usable as two-dimensional patterns for localizing (setting the position) the signal light on the spatial filter.

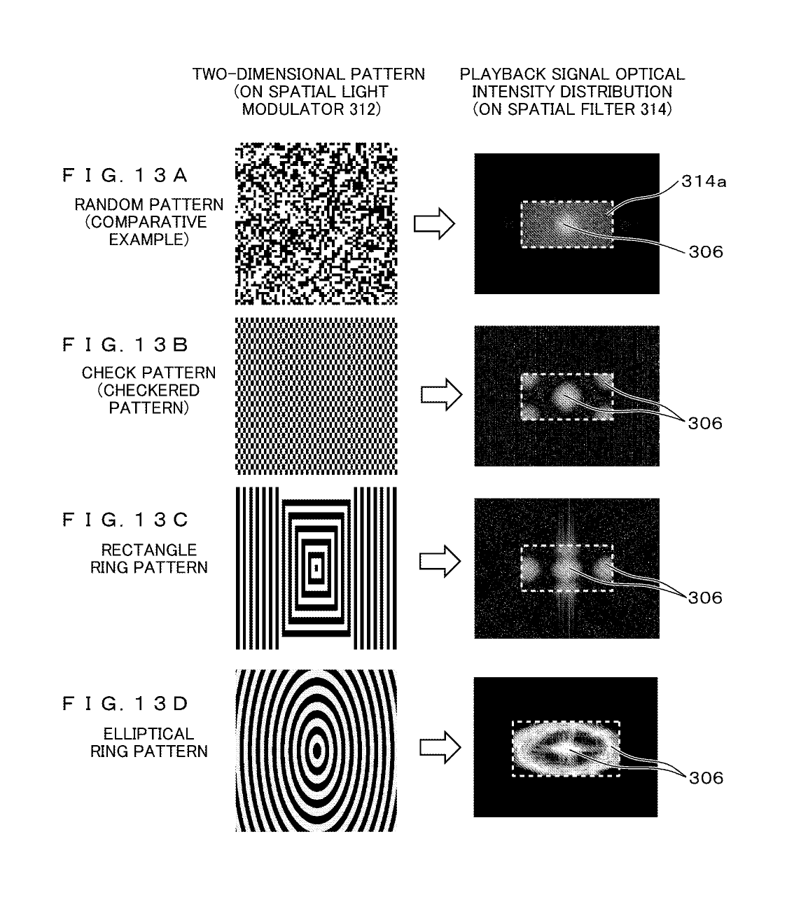

FIG. 13A, 13B, 13C, and 13D are drawings and images showing other examples of two-dimensional patterns for localizing (setting the position) the signal light. The figures show the relation between the two-dimensional pattern shown on the spatial light modulator 312, and the intensity distribution of the reproduced signal light 306 on the spatial filter 314.

FIG. 13A shows the case of a random pattern for comparison and is equivalent to a case of general recording data. The signal light is strongly localized (position is firmly set) on the spatial filter 314 and no diffracted light occurs.

FIG. 13B shows a case of a check pattern shown in FIG. 1 and shows the state where primary diffracted light occurs at the four corners of the light transmittance unit 314a.

FIG. 13C shows a case of a rectangle ring pattern, and primary diffracted light occurs along the four sides of the light transmittance unit 314a.

FIG. 13D shows a case of an elliptical ring pattern, and primary diffracted light occurs at the edges of the light transmittance unit 314a.

If there is a pattern having a cycle in the two-dimensional direction, the signal light can be localized (position set) on the periphery of the light transmittance unit 314a by the diffraction effect of that light.

A component to localize the light in the periphery of the light transmittance unit 314a of the spatial filter 314 may be utilized instead of displaying a two-dimensional pattern by the spatial light modulator 312. For example, a diffraction grating may be mounted on the optically equivalent surface to the spatial filter.

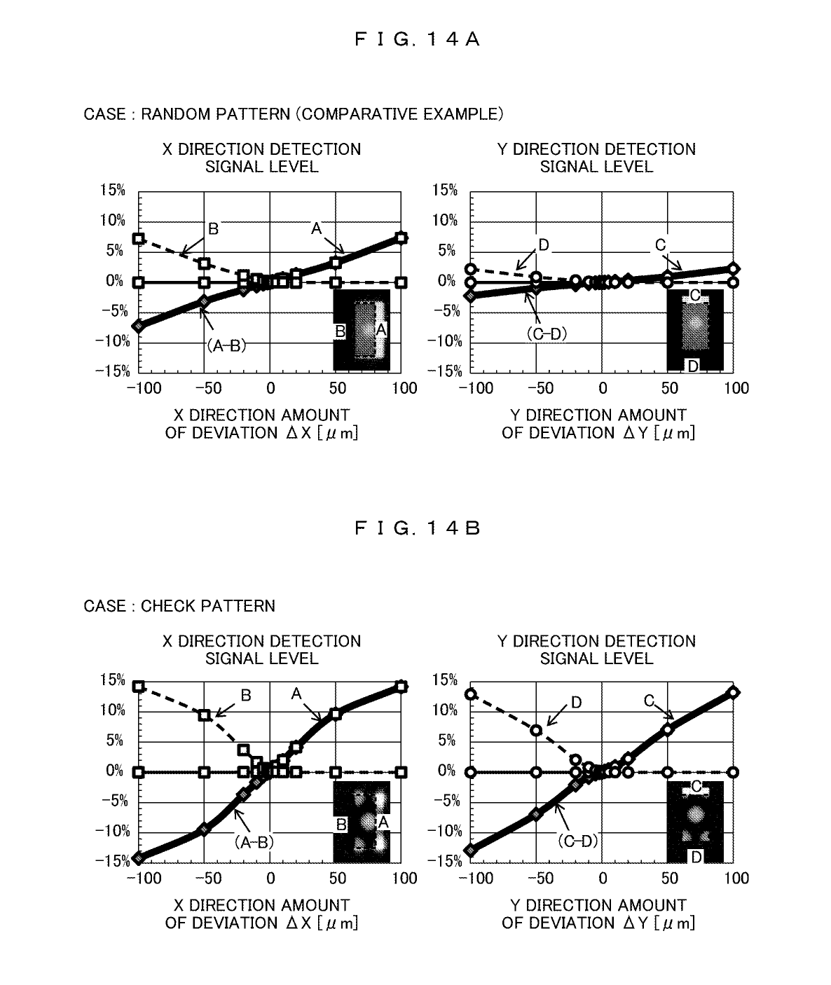

FIG. 14A and FIG. 14B are graphs showing the improvement results in the playback position deviation detection signal of the present embodiment. FIG. 14A shows the detection signal level relative to the amount of deviation along the X direction and the Y direction when a random pattern is utilized as the two-dimensional pattern for comparison. FIG. 14B shows the detection signal level relative to the amount of deviation along the X direction and the Y direction when a check pattern (FIG. 1A, FIG. 13B) is utilized in the present embodiment. The X direction and the Y direction are the directions shown in FIG. 9A, and the light transmittance unit 314a is set as a rectangular shape whose side lengths are a ratio of 1:2 and the long side is along the Y direction, and the pitch of the check pattern is set to match this shape. The detection signals along the vertical axis show the output of each of the optical detectors A through D shown in FIG. 9A and their difference signals (A-B), (C-D) as relative values.

As these results clearly show, by utilizing a check pattern compared with the case of a random pattern, the detection sensitivity (detection signal level relative to the same deviation amount) can increase, and a drastic improvement can be obtained of approximately a 3-fold increase in the X direction and approximately a 6-fold increase in the Y direction. Moreover, the detection sensitivity obtained from the check pattern is nearly equivalent in the X direction and the Y direction, and can be considered independent of the shape (aspect ratio) of the light transmittance unit 314a. This improvement in detection sensitivity is obtained identical to that in the other patterns shown in FIG. 13C and FIG. 13D.

Utilizing the optical detector 906 (A to D) of the present embodiment also allows detecting not just the playback position deviation but also amount of defocus during playback, in other words, the amount of deviation along the optical axis direction (Z direction) of the signal light. In this case also, an increase in detection sensitivity can be achieved by utilizing the check pattern.

In the present embodiment as described above, by providing a two-dimensional pattern having a cycle in at least a portion of the pattern as a servo page, the position deviation can be detected with high sensitivity for the book playback position deviation. Highly accurate positioning can in this way be achieved in high-capacity and high-density hologram recording and playback.

The present invention is not limited to the above described embodiments and may include all manner of modifications and adaptations. A detailed description of the above embodiments is given to make the present invention easy to understand, however the present invention is not necessarily limited to include all structures that were described. Moreover, a portion of the structure of the present invention may be added, deleted or replaced with other structures.

What is claimed is:

1. A hologram recording and playback device that makes reference light and signal light interfere, records the obtained interference fringe as a hologram on an optical information recording medium, and plays back the recorded hologram by emitting reference light onto an optical information record medium, the hologram recording and playback device comprising:
a light source that emits the light beam;
a branching element that branches the light beam into the reference light and the signal light;
a spatial light modulator that adds data for recording to the signal light;
a spatial filter that includes a light transmittance unit to transmit the signal light attached with data;
an objective lens that emits the signal light that passes through the spatial filter onto the optical information recording medium;
a relay lens that is mounted between the spatial light modulator and the objective lens and converges the signal light onto the position of the spatial filter;
a reference beam optical system for reproducing that emits the reference light onto the optical information recording medium;
an imaging element that emits the reference light onto a playback hologram formed on the optical information recording medium, and generates a playback signal by detecting a playback light that passes through the spatial filter from among the obtained playback light;
an optical detector that detects a playback light emitted over the periphery of the light transmittance unit of the spatial filter from among the playback light;
a playback position deviation detection unit that detects the position deviation between the reference light and a playback hologram based on the output from the optical detector; and
a position deviation correction unit that corrects the position deviation between the reference light and a playback hologram by shifting the position of the spatial filter based on a detection signal of the playback position deviation detection unit,
wherein the hologram recording and playback device records a signal light from data of a two-dimensional pattern having a cycle in at least a portion of the data induced by the spatial light modulator as a servo page during recording; and detects the position deviation between the reference light and a playback hologram by emitting the reference light onto the servo page and detecting the obtained playback light in an optical detector during playback.

2. The hologram recording and playback device according to claim 1,
wherein the two-dimensional pattern utilized in recording the servo page is a check pattern having pixels for the “1” and “0” signals are alternately arrayed along a two-dimensional direction.

3. The hologram recording and playback device according to claim 2,
wherein, when the pixel size of the check pattern in the spatial light modulator is set as px, py; and the size of the light transmittance unit of the spatial filter is set as Ax, Ay;
px≈m·f·λ/Ax, py≈n·f·λ/Ay
(m, n: integers, f: focal distance of the relay lens, λ: wavelength of light source).

4. The hologram recording and playback device according to claim 1,
wherein the optical detectors are mounted to enclose the light transmittance unit of the spatial filter from opposite directions, and the playback position deviation detection unit detects the position deviation by performing logical difference processing of the signals from the optical detectors mounted from opposite directions.

5. The hologram recording and playback device according to claim 1, further comprising an angle adjuster unit to adjust the incidence angle of the reference light onto the optical information recording medium,
wherein the hologram recording and playback device performs multiplex recording of a plurality of data pages as one book while changing the incidence angle of the reference light on the same position on the optical information recording medium,
adds and records the servo page by changing the incidence angle of the reference light on the book, and
when playing back the book, corrects the position deviations on other pages contained in the book by detecting and correcting the position deviation of the servo page contained in the book.

6. A playback position deviation detection method that plays back a hologram recorded by emitting light onto an optical information recording medium that is recorded as a hologram from the interference fringe obtained by interference between a reference light and a signal light;
wherein, when recording a two-dimensional pattern data having a cycle induced by a spatial light modulator in at least a portion of the data as a servo page onto an optical information record medium;
the playback position deviation detection method comprising the steps of:
obtaining a playback light from the servo page by emitting the reference light onto the optical information recording medium;
detecting a playback light emitted on the periphery of the light transmittance unit by an optical detector mounted on the periphery of a light transmittance unit of the spatial filter that guides the playback light into the playback imaging element; and
detecting the position deviation between the reference light and the servo page by processing the signal light from the light detector.

7. A playback position deviation detection method according to claim 6,
wherein the two-dimensional pattern recorded on the servo page is a check pattern having the pixels for signal “1” and “0” alternately arrayed in the two-dimensional direction.

8. A playback position deviation detection method according to claim 7,
wherein when the pixel size of the checkered pattern for the optical detector is px, py, and the size of the light transmittance unit of the spatial filter is Ax, Ay,
px≈m·f·λ/Ax, py≈n·f·λ/Ay
(m, n: integers, f: focal distance of the relay lens, λ: wavelength of light source).

9. A playback position deviation detection method according to claim 6,
wherein, the optical detectors are mounted to enclose the light transmittance unit of the spatial filter from opposite directions, and detect the position deviation by performing logical difference processing of the signals from the optical detectors mounted from opposite directions.

10. A playback position deviation detection method according to claim 6,
wherein multiplex recording is performed on the data pages as one book while changing the incidence angle of the reference light on the same position on the optical information record medium, and
the servo page is added and recorded by changing the incidence angle of the reference light on the book.
